(19) United States
(12) Patent Application Publication
(10) Pub. No.: US 2018/0123241 A1
(43) Pub. Date: May 3, 2018

(54) SURFACE SCATTERING ANTENNAS WITH FREQUENCY SHIFTING FOR MUTUAL COUPLING MITIGATION

(71) Applicant: Searete LLC, Bellevue, WA (US)

(72) Inventors: ERIC J. BLACK, BOTHELL, WA (US); BRIAN MARK DEUTSCH, SNOQUALMIE, WA (US); ALEXANDER REMLEY KATKO, SEATTLE, WA (US); MELROY MACHADO, SEATTLE, WA (US); JAY HOWARD MCCANDLESS, ALPINE, CA (US); YAROSLAV A. URZHUMOV, BELLEVUE, WA (US)

(21) Appl. No.: 15/338,918

(22) Filed: Oct. 31, 2016

(51) Int. Cl. H01Q 5/30; H01Q 19/06; H01Q 5/22; H01Q 1/52; H01Q 3/22

(52) U.S. Cl. CPC H01Q 5/30; H01Q 19/067; H01Q 3/22; H01Q 1/521; H01Q 5/22

(57) ABSTRACT

Inter-element couplings between radiative elements of an antenna can be reduced by increasing resonant frequencies for first selected radiative elements and decreasing resonant frequencies for second selected radiative elements. In some approaches, the radiative elements are coupled to a waveguide and the antenna configuration is a hologram that relates a reference wave of the waveguide to a radiated wave of the antenna. In some approaches, the antenna configuration is modified by identifying stationary points of the hologram and then staggering resonant frequencies for radiative elements within neighborhoods of the stationary points.

### BRIEF DESCRIPTION OF THE FIGURES

FIG. 1 depicts an example of mutual coupling between coupled oscillators.

FIGS. 2A-2C depict an example of frequency shifting for radiative elements of a surface scattering antenna.

FIG. 3 depicts a system block diagram.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

The embodiments relate to surface scattering antennas. Surface scattering antennas are described, for example, in U.S. Patent Application Publication No. 2012/0194399 (hereinafter “Bily I”). Surface scattering antennas that include a waveguide coupled to a plurality of subwavelength patch elements are described in U.S. Patent Application Publication No. 2014/0266946 (hereinafter “Bily II”). Surface scattering antennas that include a waveguide coupled to adjustable scattering elements loaded with lumped devices are described in U.S. Application Publication No. 2015/0318618 (hereinafter “Chen I”). Surface scattering antennas that feature a curved surface are described in U.S. Patent Application Publication No. 2015/0318620 (hereinafter “Black I”). Surface scattering antennas that include a waveguide coupled to a plurality of adjustably-loaded slots are described in U.S. Patent Application Publication No. 2015/0380828 (hereinafter “Black II”). And various holographic modulation pattern approaches for surface scattering antennas are described in U.S. Patent Application Publication No. 2015/0372389 (hereinafter “Chen II”). All of these patent applications are herein incorporated by reference in their entirety.

Various surface scattering antennas that are disclosed in the above patent applications often include individual radiative elements having dynamically tunable resonant frequencies, and the radiation patterns of the surface scattering antennas are then adjusted by tuning the resonant frequencies of the individual radiative elements. As a first example, Bily I describes, inter alia, radiative elements that are complementary metamaterial elements having resonant frequencies that are dynamically tunable by adjusting bias voltages applied to conducting islands within each of the complementary metamaterial elements. As a second example, Bily II describes, inter alia, radiative elements that are patch elements having resonant frequencies that are dynamically tunable by applying bias voltages between each patch and a ground plane, with an electrically adjustable material such as a liquid crystal material interposed between each patch and the ground plane. As a third example, Chin I describes, inter alia, radiative elements that are patch elements having resonant frequencies that are dynamically tunable by applying bias voltages between each patch and a ground plane, with a variable impedance lumped element connected between each patch and the ground plane. As a fourth example, Black II describes, inter alia, radiative elements that are slots having resonant frequencies that are dynamically tunable by applying bias voltages to variable impedance lumped elements that span the slots.

In some approaches, a desired antenna configuration for a surface scattering antenna may be identified by selecting resonant frequencies for the radiative elements that collectively radiate to provide the radiative field of the antenna. For example, as discussed in the above patent applications, the desired antenna configuration might be a hologram that relates a reference wave of the waveguide to a radiative wave of the antenna, where the hologram can be expressed as a plurality of couplings between the waveguide and the radiative elements, the couplings being functions of the resonant frequencies. Thus, for example, if the antenna is being operated at a selected frequency (or frequency band), the coupling between the waveguide and a radiative element falls off with increased difference between the operating frequency (or frequency band) of the antenna and the resonant frequency of the element, with the fall-off being described by a characteristic resonance curve for the element (e.g. a Lorentz resonance curve), i.e. peaking at the resonant frequency and substantially falling off when the frequency difference becomes comparable to a frequency linewidth for the element.

However, a system of radiative elements is only approximately described as system of isolated elements having individual resonant frequencies, owing to mutual couplings between the radiative elements. As the physical spacings between the radiative elements are reduced, the mutual couplings increase, so mutual coupling can become significant for a surface scattering antenna having radiative elements with subwavelength spacings between the elements. Embodiments of the present invention mitigate this mutual coupling by shifting the resonant frequencies in a manner that reduces the effects of mutual coupling.

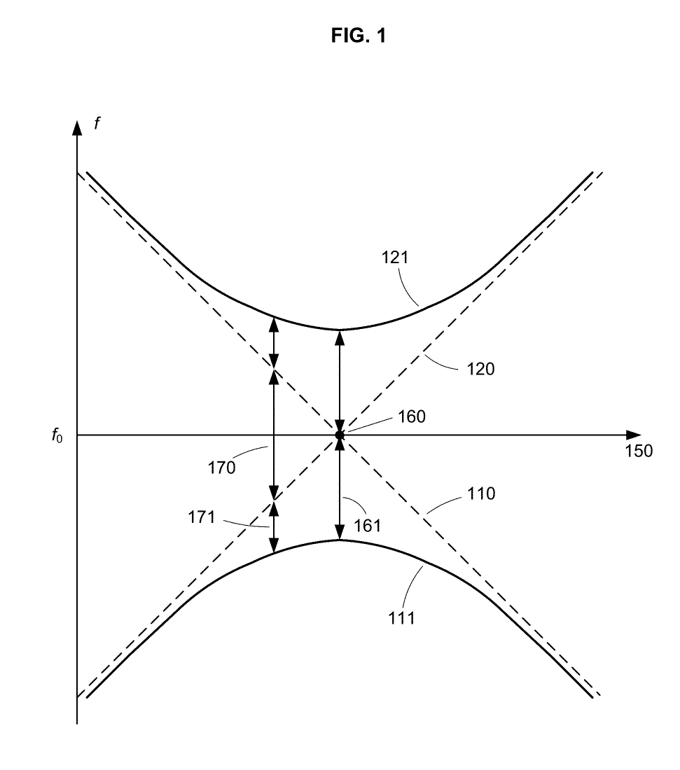

FIG. 1 illustrates how mutual coupling can be attenuated by frequency shifting. The figure depicts first and second resonant frequencies 110 and 120 for a pair of ideal, isolated oscillators, as a function of a hypothetical common parameter 150 that corresponds to a linear decrease of the first frequency 110 and a linear decrease of the second frequency 120 (for example, parameter 150 can correspond to a (parameterization of) an increasing bias voltage or incrementing grayscale tuning level for the first oscillator and a (parameterization of) a decreasing bias voltage or decrementing grayscale tuning level for the second oscillator, or vice versa). When the mutual couplings between the first and second oscillators are neglected, the first and second resonant frequencies merely cross at a frequency 160 where the resonant frequencies 110 and 120 of the isolated oscillators coincide. However, because the first and second oscillators have a mutual coupling, the pair of oscillators collectively oscillate with eigenmodes at a pair of eigenvalue frequencies 111 and 121, illustrating the familiar level repulsion effect seen in any system of coupled oscillators. At the crossover frequency 160, where the individual oscillators would have identical resonant frequencies, the mutual coupling effect is maximal in the sense that the actual resonant frequencies are different from the crossover frequency 160 by a maximal amount 161 above and below the crossover frequency. Away from the crossover frequency, e.g. when the two oscillators are detuned to have a frequency difference 170 between the isolated oscillators, as shown in FIG. 1, the mutual coupling effect is diminished in the sense that the actual resonant frequencies 111 and 121 are different from the uncoupled resonant frequencies 110 and 120 by a smaller difference 171 between the actual and uncoupled resonance frequencies.

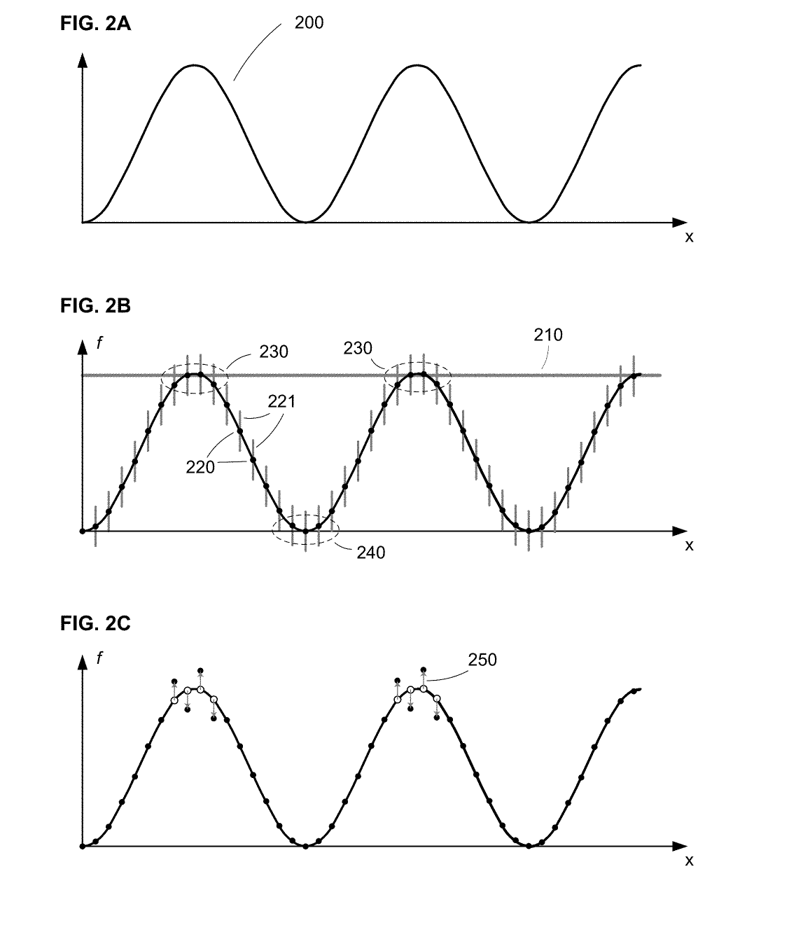

With this illustration of how frequency shifting can mitigate mutual coupling between oscillators, FIGS. 2A-2C depict an example of how the frequency shifting can be applied to the radiative elements of a surface scattering antenna. Without loss of generality, the example relates to a one-dimensional surface scattering antenna that includes a plurality of radiative elements distributed along the length of a one-dimensional wave-propagating structure. Suppose that the desired antenna configuration is a hologram that relates a reference wave of the waveguide to a radiative wave of the antenna. This hologram is schematically depicted as the sinusoid 200 in FIG. 2A. As discussed above, this hologram might be expressed as a plurality of couplings between the waveguide and the radiative elements, the couplings being functions of the resonant frequencies. Thus, as schematically depicted in FIG. 2B, treating the plurality of radiative elements as a system of isolated elements having individual resonant frequencies, the individual resonant frequencies of the radiative elements can be tuned depending upon their positions along the sinusoidal hologram, to thereby implement the sinusoidal hologram and provide the desired antenna radiation pattern. In this schematic illustration, the vertical axis is a frequency axis; the operating frequency (or frequency band) of the antenna is represented by the horizontal bar 210, while the individual resonant responses of the individual radiative elements are represented by the dots 220 (representing the resonant frequencies of the individual oscillators) and the bars 221 (representing the linewidths of the individual oscillators).

When the effects of mutual coupling are considered, the largest effects are likely to occur between neighboring radiative elements having resonant frequencies that are close together and also close to the operating frequency (or frequency band) 210, i.e. providing maximal coupling to the guided wave at the operating frequency (or frequency band). For example, the neighboring elements 230 in a vicinity of a maximum stationary point of the hologram function are likely susceptible to strong mutual coupling because they are strongly driven by to the guided wave mode and also close together in resonant frequency. On the other hand, if the neighboring radiative elements have resonant frequencies that are close together but far away from the operating frequency, the mutual coupling effect between those neighboring radiative elements is lessened because the neighboring radiative elements are not strongly driven by the guided wave mode at the operating frequency (or frequency band). For example, the neighboring elements 240 in a vicinity of a minimal stationary point of the hologram function are not likely susceptible to strong mutual coupling, even though they are close together in resonant frequency, because none of the neighboring elements 240 is strongly driven by the guided wave mode.

Thus, to effectively mitigate mutual coupling effects, it is appropriate to focus on neighboring elements (such as the elements 230 of FIG. 2B) that are situated at or near maximal (strongly driven) stationary points of the hologram function. Here, “maximal” does not necessarily mean that the stationary point is an absolute maximum of the hologram function—it can be any stationary point of the hologram function that is implemented by strong coupling between the reference wave and the radiative elements in a neighborhood of the stationary point. To mitigate the mutual coupling between these strongly driven radiative elements, the resonant frequencies of the elements can be “staggered” by increasing the resonant frequencies of some of the neighboring elements and decreasing the resonant frequencies of other of the neighboring elements. This is schematically depicted in FIG. 2C, wherein the resonant frequencies of the neighboring elements 230 are alternatively shifted up and down by frequency offsets 250. While these frequency offsets represent a departure from the ideal holographic distribution of resonant frequencies 220 as shown in FIG. 2B, the ideal holographic distribution of FIG. 2B ignores the effects of mutual coupling between neighboring elements. The frequency shifting is designed to diminish the mutual coupling effects without unduly distorting the ideal holographic distribution, to restore the desired effect (i.e. the desired antenna radiation pattern) of the ideal holographic distribution.

In some approaches, the neighboring elements whose resonant frequencies are staggered (such as the elements 230 of FIG. 2B) are elements within a selected neighborhood of a maximal stationary point of the hologram function. As discussed above, a maximal stationary point is a stationary point of the hologram function that corresponds to strong, as opposed to weak, coupling between the reference wave and the elements in a the vicinity of the stationary point. The selected neighborhood can include all radiative elements within a selected radius of the maximal stationary point. For example, the selected radius can be equal to some fraction of a wavelength of the reference wave, e.g. a radius of one wavelength of the reference wave, three-quarters of the wavelength of the reference wave, one-half of the wavelength of the reference wave, one-quarter of the wavelength of the reference wave, etc. In some approaches, the surface scattering antenna includes a two-dimensional waveguide such as a parallel-plate waveguide, and the selected neighborhood includes all elements within a two-dimensional disc having the selected radius and centered on the maximal stationary point. In other approaches, the surface scattering antenna includes one or more one-dimensional waveguide fingers, and the selected neighborhood includes all elements within a one-dimensional interval along a selected finger, having the selected radius (i.e. having a range of twice the selected radius) and centered on the maximal stationary point. While the above discussion has focused on a single maximal stationary point, it will be appreciated that, for a given surface scattering antenna and a given hologram antenna, there may be any number of maximal stationary points, each corresponding to a local maximum of the hologram function, and thus a number of neighborhoods wherein the resonant frequencies of the neighboring elements are staggered. For example, for a surface scattering antenna that includes a set of one-dimensional waveguide fingers, the hologram function may be defined as a sinusoid on each finger, and for each finger, there is a maximal stationary point for each peak of the sinusoid, and thus a neighborhood of each sinuosoid peak wherein the resonant frequencies of the radiative elements are staggered to mitigate mutual coupling.

In various approaches, the amount of the frequency shifting can be constant within a selected neighborhood (with each element's resonant frequency shifted either up or down by a constant amount that does not vary within the neighborhood) or varied within the selected neighborhood (with each elements' resonant frequency shifted either up or down by an amount that varies within the neighborhood). Approaches that use constant frequency shifting can include using frequency shifts equal to some fraction of a resonance linewidth of a radiative element, e.g. one resonance linewidth, one-half of a resonance linewidth, one-quarter of a resonance linewidth, one-tenth of a resonance linewidth, etc. Approaches that use varied frequency shifting can include using frequency shifts with magnitudes that decrease with distance from the stationary point, or using frequency shifts that reflect the resonant frequency across an operating frequency. In the former approach, the frequency shifts might be characterized in terms of a dimensional scale factor multiplied by a dimensionless function that falls off, e.g. exponentially or as a power law, with distance from the stationary point. The dimensional scale factor can equal some fraction of a resonance linewidth of a radiative element, as above. In the latter approach, supposing that the antenna is operating at a frequency f₀, if the ideal hologram prescribes that a radiative element have a resonant frequency f₀−δ, the radiative element can instead be frequency-shifted to have a resonant frequency f₀+δ. This would provide a coupling of the same amplitude, albeit with different phase, between the reference wave and the element in question, supposing, as is likely the case, that the amplitude frequency response of the element is symmetric or nearly symmetric about its resonant frequency.

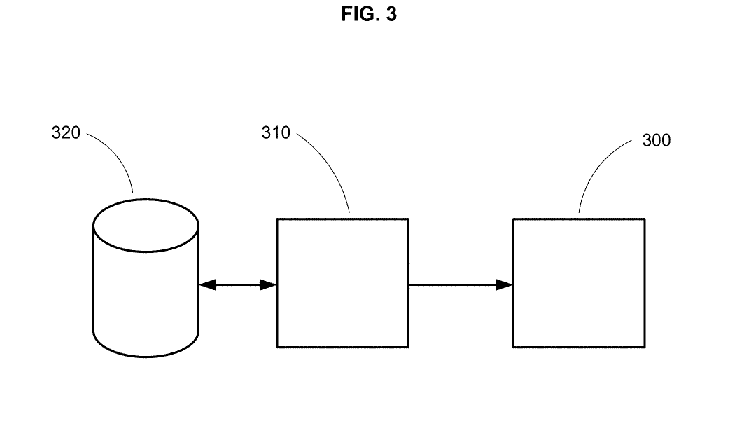

With reference now to FIG. 3, an illustrative embodiment is depicted as a system block diagram. The system includes an antenna 300 coupled to control circuitry 310 operable to adjust the surface scattering to provide particular antenna configurations. The antenna includes plurality of adjustable radiative elements having a respective plurality of adjustable resonant frequencies, as discussed above. It will be appreciated that the inclusion of the antenna 300 within the system is optional; in some approaches, the system omits the antenna and is configured for later connection to such an antenna. The system optionally includes a storage medium 320 on which is written a set of pre-determined antenna configurations. For example, the storage medium may include a set of antenna configurations, each stored antenna configuration being previously determined according to one or more of the approaches set forth above. In other words, the storage medium may include a set of antenna configurations that are selected to increase first selected resonant frequencies for first selected radiative elements and to decrease second selected resonant frequencies for second selected radiative elements adjacent to the first selected radiative elements, whereby to reduce couplings between the first selected radiative elements and the second selected radiative elements Then, the control circuitry 310 would be operable to read an antenna configuration from the storage medium and adjust the antenna to the selected, previously-determined antenna configuration. Alternatively, the control circuitry 310 may include circuitry operable to calculate an antenna configuration according to one or more of the approaches described above, and then to adjust the antenna for the presently-determined antenna configuration.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

One skilled in the art will recognize that the herein described components (e.g., steps), devices, and objects and the discussion accompanying them are used as examples for the sake of conceptual clarity and that various configuration modifications are within the skill of those in the art. Consequently, as used herein, the specific exemplars set forth and the accompanying discussion are intended to be representative of their more general classes. In general, use of any specific exemplar herein is also intended to be representative of its class, and the non-inclusion of such specific components (e.g., steps), devices, and objects herein should not be taken as indicating that limitation is desired.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

With respect to the appended claims, those skilled in the art will appreciate that recited operations therein may generally be performed in any order. Examples of such alternate orderings may include overlapping, interleaved, interrupted, reordered, incremental, preparatory, supplemental, simultaneous, reverse, or other variant orderings, unless context dictates otherwise. With respect to context, even terms like “responsive to,” “related to,” or other past-tense adjectives are generally not intended to exclude such variants, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method, comprising:
identifying a desired antenna configuration that defines a plurality of resonant frequencies for a respective plurality of radiative elements of an antenna; and
modifying the desired antenna configuration to increase resonant frequencies for first selected radiative elements and to decrease resonant frequencies for second selected radiative elements adjacent to the first selected radiative elements, whereby to reduce couplings between the first selected radiative elements and the second selected radiative elements.

2. The method of claim 1, further comprising:
adjusting the antenna to provide the modified antenna configuration.

3. The method of claim 1, further comprising:
operating the antenna with the modified antenna configuration.

4. The method of claim 1, further comprising:
storing the modified antenna configuration in a storage medium.

5. The method of claim 1, wherein the radiative elements are coupled to a waveguide and the desired antenna configuration is a hologram that relates a reference wave of the waveguide to a radiated wave of the antenna, where the hologram can be expressed as a plurality of couplings between the waveguide and the radiative elements, the couplings being functions of the resonant frequencies.

6. The method of claim 5, wherein the modifying of the desired antenna configuration includes:
identifying a set of stationary points of the hologram; and
for each stationary point in the set of stationary points:
identifying radiative elements within a subwavelength neighborhood of the stationary point; and
staggering the resonant frequencies for the radiative elements within the subwavelength neighborhood.

7. (canceled)

8. (canceled)

9. The method of claim 6, wherein each subwavelength neighborhood includes all radiative elements within a selected radius of the stationary point.

10. (canceled)

11. (canceled)

12. (canceled)

13. The method of claim 6, wherein the waveguide includes a set of one-dimensional waveguide fingers and the hologram is a set of sinusoidal holograms for the set of waveguide fingers.

14. (canceled)

15. (canceled)

16. The method of claim 13, wherein, for each waveguide finger, each subwavelength neighborhood includes all radiative elements coupled to the waveguide finger and within a selected radius of the stationary point.

17. (canceled)

18. (canceled)

19. The method of claim 16, wherein the staggering of the resonant frequencies includes alternatively increasing and decreasing the resonant frequencies for successive elements within the subwavelength neighborhood.

20. The method of claim 6, wherein the staggering of the resonant frequencies includes:
for some radiative elements within the subwavelength neighborhood, increasing the resonance frequencies by a first selected frequency shift amount; and
for other radiative elements within the subwavelength neighborhood, decreasing resonance frequencies by a second selected frequency shift amount.

21. (canceled)

22. The method of claim 20, wherein the first selected frequency shift amount is less than or equal to a resonance linewidth of the radiative elements.

23. (canceled)

24. (canceled)

25. A system for operating an antenna with a plurality of adjustable radiative elements having a respective plurality of adjustable resonant frequencies, comprising:
a storage medium on which a set of antenna configurations is written, each antenna configuration being selected to increase first selected resonant frequencies for first selected radiative elements and to decrease second selected resonant frequencies for second selected radiative elements adjacent to the first selected radiative elements, whereby to reduce couplings between the first selected radiative elements and the second selected radiative elements; and
control circuitry operable to read antenna configurations from the storage medium and adjust the plurality of adjustable scattering elements to provide the antenna configurations.

26. The system of claim 25, further comprising:
the antenna with the plurality of adjustable radiative elements having the respective plurality of adjustable resonant frequencies.

27. The system of claim 25, wherein the radiative elements are coupled to a waveguide and each antenna configuration corresponds to hologram that relates a reference wave of the waveguide to a radiated wave of the antenna, where the hologram can be expressed as a plurality of couplings between the waveguide and the radiative elements, the couplings being functions of the resonant frequencies.

28. The system of claim 27, wherein each antenna configuration is selected by an algorithm that includes:
identifying a set of stationary points of the hologram; and
for each stationary point in the set of stationary points:
identifying radiative elements within a subwavelength neighborhood of the stationary point; and
staggering the resonant frequencies for the radiative elements within the subwavelength neighborhood.

29. (canceled)

30. (canceled)

31. The system of claim 28, wherein each subwavelength neighborhood includes all radiative elements within a selected radius of the stationary point.

32. (canceled)

33. (canceled)

34. (canceled)

35. The system of claim 28, wherein the waveguide includes a set of one-dimensional waveguide fingers and the hologram is a set of sinusoidal holograms for the set of waveguide fingers.

36. (canceled)

37. (canceled)

38. The system of claim 35, wherein, for each waveguide finger, each subwavelength neighborhood includes all radiative elements coupled to the waveguide finger and within a selected radius of the stationary point.

39. (canceled)

40. (canceled)

41. The system of claim 16, wherein the staggering of the resonant frequencies includes alternatively increasing and decreasing the resonant frequencies for successive elements within the subwavelength neighborhood.

42. The system of claim 28, wherein the staggering of the resonant frequencies includes:
for some radiative elements within the subwavelength neighborhood, increasing the resonance frequencies by a first selected frequency shift amount; and
for other radiative elements within the subwavelength neighborhood, decreasing resonance frequencies by a second selected frequency shift amount.

43. (canceled)

44. The system of claim 42, wherein the first selected frequency shift amount is less than or equal to a resonance linewidth of the radiative elements.

45. (canceled)

46. (canceled)

47. A method of controlling an antenna with a plurality of adjustable radiative elements having a respective plurality of adjustable resonant frequencies, comprising:
reading an antenna configuration from a storage medium, the antenna configuration being selected to increase first selected resonant frequencies for first selected radiative elements and to decrease second selected resonant frequencies for second selected radiative elements adjacent to the first selected radiative elements, whereby to reduce couplings between the first selected radiative elements and the second selected radiative elements; and
adjusting the antenna to provide the antenna configuration.

48. The method of claim 47, further comprising:
operating the antenna in the antenna configuration.

49. The method of claim 47, wherein the radiative elements are coupled to a waveguide and the antenna configuration corresponds to hologram that relates a reference wave of the waveguide to a radiated wave of the antenna, where the hologram can be expressed as a plurality of couplings between the waveguide and the radiative elements, the couplings being functions of the resonant frequencies.

50. The method of claim 49, wherein the antenna configuration is selected by an algorithm that includes:
identifying a set of stationary points of the hologram; and
for each stationary point in the set of stationary points:
identifying radiative elements within a subwavelength neighborhood of the stationary point; and
staggering the resonant frequencies for the radiative elements within the subwavelength neighborhood.

51. (canceled)

52. (canceled)

53. The method of claim 50, wherein each subwavelength neighborhood includes all radiative elements within a selected radius of the stationary point.

54. (canceled)

55. (canceled)

56. (canceled)

57. The method of claim 50, wherein the waveguide includes a set of one-dimensional waveguide fingers and the hologram is a set of sinusoidal holograms for the set of waveguide fingers.

58. (canceled)

59. (canceled)

60. The method of claim 57, wherein, for each waveguide finger, each subwavelength neighborhood includes all radiative elements coupled to the waveguide finger and within a selected radius of the stationary point.

61. (canceled)

62. (canceled)

63. The method of claim 60, wherein the staggering of the resonant frequencies includes alternatively increasing and decreasing the resonant frequencies for successive elements within the subwavelength neighborhood.

64. The method of claim 50, wherein the staggering of the resonant frequencies includes:
for some radiative elements within the subwavelength neighborhood, increasing the resonance frequencies by a first selected frequency shift amount; and
for other radiative elements within the subwavelength neighborhood, decreasing resonance frequencies by a second selected frequency shift amount.

65. (canceled)

66. The method of claim 64, wherein the first selected frequency shift amount is less than or equal to a resonance linewidth of the radiative elements.

67. (canceled)

68. (canceled)
